(19) United States
(12) Patent Application Publication
(10) Pub. No.: US 2005/0168911 A1
(43) Pub. Date: Aug. 4, 2005

(54) Capacitor module and capacitor battery comprising the same

(76) Inventor: Bernd Staib, Syrgenstein (DE)

Correspondence Address: FISH & RICHARDSON PC, 225 FRANKLIN ST, BOSTON, MA, 02110, US

(21) Appl. No.: 10/512,147

(22) PCT Filed: Apr. 11, 2003
(86) PCT No.: PCT/DE03/01209

(30) Foreign Application Priority Data
Apr. 24, 2002 (DE) 102 18 295.7

(51) Int. Cl. H01G 4/00

(52) U.S. Cl. 361/301.3

(57) ABSTRACT

A capacitor module (1) is proposed, in which a first (10A) and a second capacitor (10B) are located, in each instance, in separate, metallically conductive housings (5A, 5B) that are tightly sealed from one another. The two housings are connected with one another by way of a contact surface, wherein an internal electrical circuit comes about. Each housing has at least one first connector (2A, 2B) that is electrically insulated from the housing, in each instance. Because of the direct electrical connection between the two capacitors, a capacitor module according to the invention requires fewer screw connections and thereby can be produced in simpler and more cost-advantageous manner.

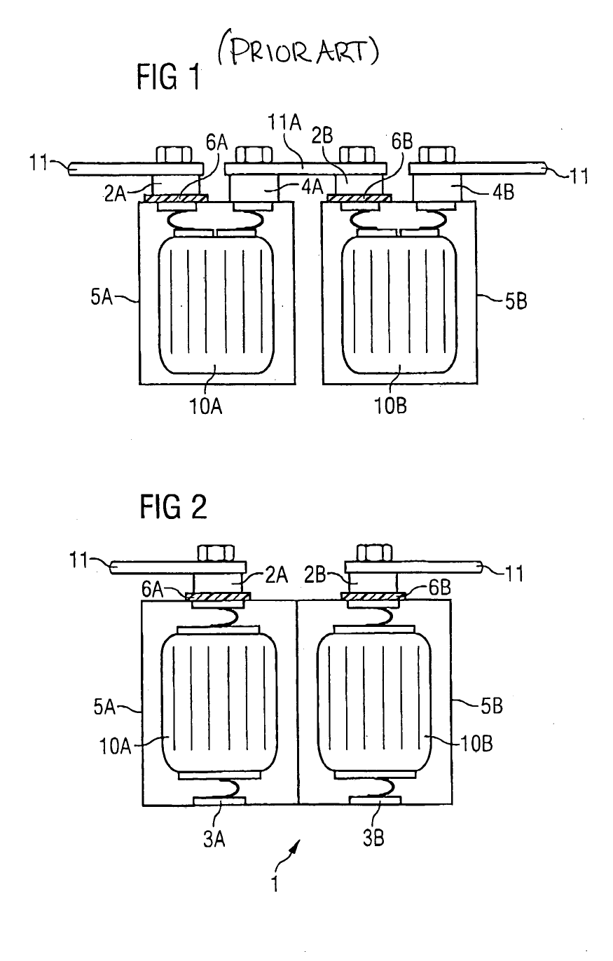

In the case of capacitors, for example double-layer capacitors, the cell voltage is limited to a few volts. Since, in the case of most applications, the operating voltages are significantly higher, several capacitors have to be connected in series to produce a capacitor module. In the case of conventional capacitor modules, individual capacitors are connected with additional capacitors by way of current rails, by means of screw connections (see FIG. 1). Such conventional capacitor modules have the disadvantage that because of the numerous screw connections, a significant expenditure of assembly effort is required; this is very time-intensive and cost-intensive, and increases the internal resistance of the capacitor module.

It is the aim of the present invention to provide a capacitor module that is improved with reference to the aforementioned disadvantages.

This aim is achieved, according to the invention, by means of a capacitor module as recited in claim 1. Advantageous embodiments of the capacitor module, as well as a capacitor battery having the capacitor module, are the object of dependent claims.

The invention relates to a capacitor module in which a first and a second capacitor are each located in separate, metallically conductive housings that are tightly sealed from one another. Each of the housings represents a pole of the capacitors, in each instance, wherein the two housings are directly connected with one another by way of a mutual contact surface, with at least a partial positive lock. In this arrangement, an internal electrical circuit comes about. Each capacitor has at least one first connector, in each instance, for external electrical contacting of the module, which connector is electrically insulated from the housing.

The advantage of a capacitor module according to the invention includes the fact that the two electrically conductive housings, in which the capacitors are accommodated, in each instance, directly touch one another by way of a contact surface. Since there is a direct electrical connection between the two housings (see FIG. 2), those screw connections that served for contacting between the two capacitors until now, in the case of conventional capacitor modules (see FIG. 1), can be eliminated. For this reason, capacitor modules according to the invention can be produced more cost-effectively than conventional modules, with less assembly effort. Furthermore, capacitor modules according to the invention also have a lower weight, as well as a lower internal resistance, than conventional capacitor modules, and this has a particularly advantageous effect on the use of the capacitor modules according to the invention in automotive applications, for example in automobiles. Because of the close thermal coupling of the two capacitors in the capacitor module according to the invention, the different spontaneous discharge behavior of the two capacitors is also balanced out, at least in part, so that the complicated measures for making the voltage symmetrical, as mentioned above, are eliminated in the case of capacitor modules according to the invention. The direct contact between the two metallically conductive housings therefore makes a particularly simple serial circuit of capacitors possible, in a capacitor module according to the invention. The capacitor housings are tightly sealed from one another and separated, in order to assure that the electrolyte is not exposed to any overly high electrical voltage.

The first connectors, which are electrically insulated from the housing, generally serve to contact the capacitors located in the housing, which are present, for example, in the form of capacitor films. Capacitors generally consist of two electrode layers, between which a porous separator is arranged. Both the separator and the electrode layer are in contact with an electrolyte solution. The layer arrangements of the electrode layers and the separators can be rolled up to produce capacitor coils.

In another embodiment of the invention, the capacitor module has at least one second electrical connector, connected with the housing in an electrically conductive manner. In this way it is possible to also electrically contact the capacitor housing, which has a different potential applied to it from that of the capacitor, so that in the case of a capacitor module according to the invention, parallel circuits of capacitors are also possible.

In another advantageous embodiment of the invention, the housings of the capacitors have a rectangular cross-section, in each instance. This means that the housing is rectangular. However, it is also possible that the housings are flattened off or rounded off at the corners. Rectangular housings can be accommodated in capacitor modules in a particularly space-saving manner.

In the case of another advantageous variant of the invention, the two housings are arranged in the capacitor module at least partly with a positive lock, so that a contact surface is formed between two housings. This has the advantage that because of a large contact surface, a particularly good electrical connection comes about between two housings in the capacitor module according to the invention.

In another embodiment, the housings each have a round cross-section. This means that the capacitor housings are shaped cylindrically, for example. In the case of this variant, the flat bottoms of the two housings can be connected with a metal plate, in an electrically conductive manner. This means that in the case of cylindrical housings, an electrical connection comes about not only by means of direct contacting of the two housings, but also, additionally, by means of an electrically conductive plate that is connected with the two housings in an electrically conductive manner.

Furthermore, it is possible that in the case of cylindrical housings, the bottoms of the two housings are arranged with at least a partial positive lock, and therefore can form a contact surface if they are appropriately arranged coaxially one behind the other. In this manner, a particularly large contact surface comes about, even in the case of cylindrical housings of a capacitor module according to the invention, and this allows for a particularly good electrical connection between the two capacitors.

It is furthermore possible that all the electrical connectors are arranged on the same surface of the capacitor module. This so-called radial construction allows for a particularly cost-effective structure of capacitor modules, at a low installation volume, since the capacitors are contacted only from one side.

In another advantageous variant of a capacitor module according to the invention, the two housings are welded to one another. This has the advantage that a particularly good and permanent electrical connection between the two housings comes about, which connection can also withstand mechanical stress. Furthermore, welding also offers protection against oxidation of the contact surface.

It is also possible to screw the two capacitor housings together, for example, or to connect them with one another by accommodating them in a single larger housing.

If at least one capacitor module according to the invention is connected with other capacitor modules and/or capacitors, this results in a capacitor battery. Generally, the individual modules or individual capacitors in a capacitor battery are connected in series. A capacitor battery having capacitor modules according to the invention has the advantage, as is also the case when connecting individual capacitors in series, that half of the screw connections and the related problems, for example the great assembly effort, can be eliminated.

In the following, the invention will be explained in greater detail, using exemplary embodiments and their figures.

FIG. 1 shows a conventional capacitor module,

FIG. 2 shows a variant of a capacitor module according to the invention.

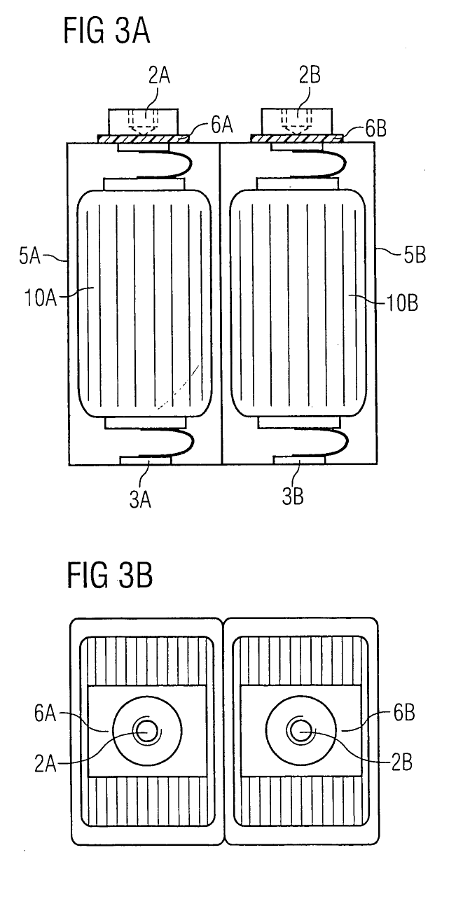

FIGS. 3A and 3B show a variant of a capacitor module according to the invention in cross-section and in a top view, in which the capacitors, in each instance, are contacted axially.

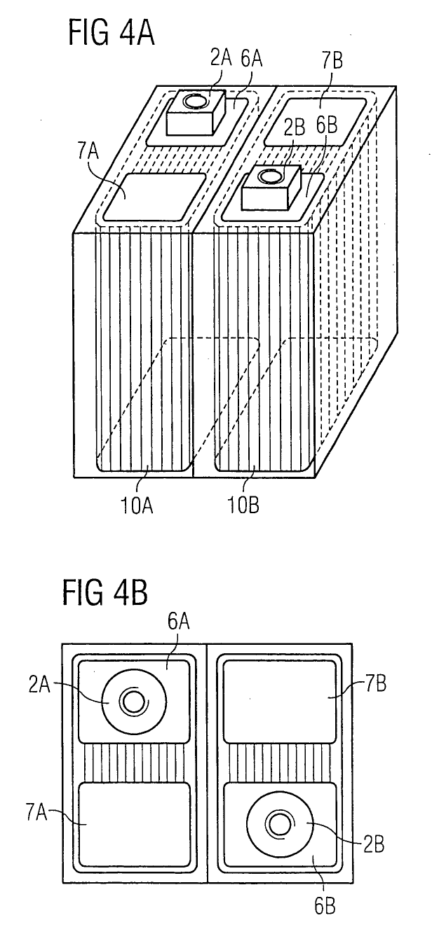

FIGS. 4A and 4B show another variant of a capacitor module according to the invention, in a perspective view and in a top view, in which the capacitors, in each instance, are contacted radially.

FIG. 5 shows an advantageous embodiment of a capacitor module according to the invention, with tube-shaped capacitor housings.

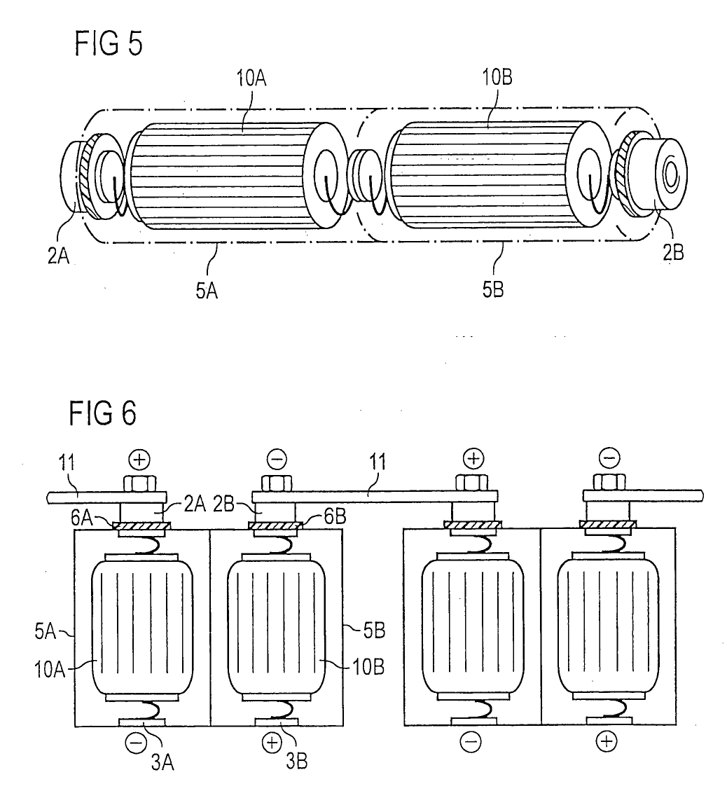

FIG. 6 shows a capacitor battery in which two capacitor modules according to the invention are connected together.

FIG. 1 shows a conventional capacitor module, in which the housings 5A and 5B of the individual capacitors 10A and 10B do not make direct contact. The individual capacitors 10A and 10B can be present, for example, in the form of capacitor coils. These capacitor coils contact first electrical connectors 2A and 2B, in each instance, which are each electrically insulated from the capacitor housings, in each instance, by means of insulation rings 6A or 6B. These first electrical connectors contact a first electrode film in the capacitor coils. The second electrode film in the capacitor coils, in each instance, contacts the second electrical connectors 4A and 4B, respectively, which are connected with the capacitor housings, in each instance, in an electrically conductive manner. The capacitor housings therefore have a potential applied to them. Electrical contacting between the two capacitors of the conventional capacitor module therefore takes place by way of the contact plate 11A and corresponding screw connections between the electrical connectors 4A and 2B. As already described above, this conventional method of contacting is very time-consuming and material-intensive, and therefore also cost-intensive.

FIG. 2 shows a variant of a capacitor module 1 according to the invention, in which the two capacitor housings 5A and 5B have a rectangular cross-section. The two housings contact one another by way of their side surfaces, so that a contact surface is formed that allows a direct electrical connection between the two capacitor housings and therefore also between the two capacitors 10A and 10B. In this process, an electrode film of the capacitors, in each instance, which are shown as capacitor coils here, as an example, contacts the first electrical connectors 2A and 2B, in each instance, and the latter are electrically insulated from their housings, in each instance, by means of the insulation rings 6A and 6B. The second electrode films of the capacitor coils 10A and 10B, in each instance, contact their housings, in each instance, by way of the contact points 3A and 3B, so that the housings have the potential of the second electrode film applied to them. A comparison of FIGS. 1 and 2 makes it clear that the contacting between the capacitors and the two connectors 4a and 2b that is provided by the additional contact plate 11A can be eliminated in the case of capacitor modules according to the invention.

FIG. 3a shows a variant of a capacitor module according to the invention, in cross-section, in which the capacitor coils, which are accommodated in rectangular housings, are contacted axially. This means that the two electrode films of each capacitor coil are contacted on opposite faces of the housing. In this case, one electrode film contacts the connectors 2A and 2B, in each instance, while the other electrode film contacts the housing by way of the contact points 3A and 3B.

FIG. 3B shows the capacitor module shown in FIG. 3A in cross-section, in a top view. The first electrical connectors 2A and 2B, in each instance, can be seen; they are insulated from their housings, in each instance, by means of the insulation disks 6A and 6B, in each instance.

FIG. 4a shows an embodiment of a capacitor module according to the invention in a perspective view, in which the electrode films of the capacitor coils 10A and 10B are contacted radially. This means that the two electrode films in a capacitor are contacted on the same side of their electrical connector, i.e., of the housing. In this embodiment, the electrode films of the capacitor coil, in each instance, contact the first electrical connectors 2A and 2B, respectively, or the contacting points 7A and 7B, respectively, with their housings, in each instance. Such capacitor modules having rectangular capacitor housings and radial contacting allow for a particularly space-saving structure of capacitor batteries.

FIG. 4B shows a top view of the capacitor module according to the invention shown in FIG. 4A in a perspective view. The first electrical connectors 2A and 2B; respectively, and the contacting points 7A and 7B for the housing can be seen, in each instance.

FIG. 5 shows another embodiment of a capacitor module according to the invention, having two coaxial, cylindrical capacitor housings 5A and 5B. It can be seen that in the case of this variant, the capacitor housings contact one another by way of their bottoms, which are formed to be flat, in each instance, with a positive lock. In the case of tube-shaped capacitor housings, the flat upper and lower ends of the tubes are referred to as bottoms. This method of contacting allows for a particularly large contact surface between the two housings and therefore a particularly good electrical connection, in the case of tube-shaped capacitor housings.

FIG. 6 shows a capacitor battery in which two capacitor modules according to the invention are connected in series. The electrical potentials of the first electrical connectors, in each instance, or of the contacting points to the housing, are designed for serial connection, as an example. Such a capacitor battery requires significantly fewer screw connections than conventional capacitor batteries. Each of the two housings (5A, 5B) represents a pole of one of the capacitors (10A, 10B), in each instance. The two housings are directly connected with one another by way of a mutual contact surface, at least partly with a positive lock, bringing about an internal electrical circuit. In this arrangement, the two capacitors (10A, 10B) have a different poling relative to their housings, inverse to one another, in each instance, resulting in an internal serial connection of the two capacitors (10A, 10B).

Further variations of a capacitor module according to the invention are furthermore possible, in the case of the embodiments of the capacitors, which can also consist of layer stacks that are not rolled up, for example, instead of the capacitor coils shown here.

1. A capacitor module comprising:
a first housing for holding a first capacitor, the first housing being conductive and corresponding to a pole of the first capacitor, the first housing comprising a first contact surface; and
a second housing for holding a second capacitor, the second housing being conductive and corresponding to a pole of the second capacitor, the second housing comprising a second contact surface;
wherein the first housing and the second housing are substantially sealed from one another;
wherein the first contact surface and the second contact surface contact one another and are locked together resulting in formation of an electrical circuit; and
wherein each of the first capacitor and the second capacitor comprises an external contact that is electrically insulated from the first housing or the second housing.

2. The capacitor module of claim 1, wherein the first and second capacitors have inverse poles; and
wherein the electrical circuit comprises a series circuit that includes the first and second capacitors.

3. The capacitor module of claim 1, further comprising:
a first electrical contact between the first housing and the first capacitor; and
a second electrical contact between the second housing and the second capacitor.

4. The capacitor module of claim 1, wherein the first housing and the second housing each have a cross-section that is substantially rectangular.

5. The capacitor module of claim 1, wherein each of the first and second housings has a cross-section that is substantially round; and
wherein the first and second housings comprise bottoms that are connected with a metal plate resulting in an electrical connection.

6. The capacitor module of claim 1, wherein the first housing and the second housing each have a cross-section that is substantially round; and
wherein the first and second housings comprise bottoms that are arranged to form at least a partial positive lock, where a bottom of the first housing comprises the first contact surface and a bottom of the second housing comprises the second contact surface.

7. The capacitor module of claim 1, wherein all electrical connections between the first housing and the second housing are on a mutual contact surface of the first and second housings.

8. The capacitor module of claim 1, wherein the first housing and the second housing are welded to one another.

9. A capacitor battery comprising:
at least one capacitor module according to claim 1 connected to another capacitor module according to claim 1 and/or to a capacitor.

10. The capacitor module of claim 2, further comprising:
a first electrical contact between the first housing and the first capacitor; and
a second electrical contact between the second housing and the second capacitor.

11. The capacitor module of claim 2, wherein the first housing and the second housing each have a cross-section that is substantially rectangular.

12. The capacitor module of claim 2, wherein each of the first and second housings has a cross-section that is substantially round; and
wherein the first and second housings comprise bottoms that are connected with a metal plate resulting in an electrical connection.

13. The capacitor module of claim 2, wherein the first housing and the second housing each have a cross-section that is substantially round; and
wherein the first and second housings comprise bottoms that are arranged to form at least a partial positive lock, where a bottom of the first housing comprises the first contact surface and a bottom of the second housing comprises the second contact surface.

14. The capacitor module of claim 2, wherein all electrical connections between the first housing and the second housing are a mutual contact surface of the first and second housings.

15. The capacitor module of claim 2, wherein the first housing and the second housing are welded to one another.

16. A capacitor module comprising:
a first housing for holding a first capacitor, the first housing being conductive, the first housing comprising a first contact surface; and
a second housing for holding a second capacitor, the second housing being conductive, the second housing comprising a second contact surface;
wherein the first contact surface and the second contact surface contact one another and are locked together resulting in formation of an electrical circuit; and
wherein each of the first capacitor and the second capacitor comprises an external contact that is electrically insulated from the first housing or the second housing.

17. The capacitor module of claim 16, wherein the first housing and the second housing each have a cross-section that is substantially round; and
wherein the first and second housings comprise bottoms that are arranged to form at least a partial positive lock, where a bottom of the first housing comprises the first contact surface and a bottom of the second housing comprises the second contact surface.

18. The capacitor module of claim 16, wherein all electrical connections between the first housing and the second housing are a mutual contact surface of the first and second housings.

19. The capacitor module of claim 16, wherein the first housing and the second housing are welded to one another.

20. The capacitor module of claim 16, wherein the first and second capacitors have different poles.
